(19) United States
(12) Patent Application Publication
(10) Pub. No.: US 2026/0145030 A1
(43) Pub. Date: May 28, 2026

(54) EXERCISE ASSISTANCE DEVICE, EXERCISE ASSISTANCE METHOD, AND NON-TRANSITORY COMPUTER READABLE MEDIUM

(71) Applicant: NEC Corporation, Tokyo (JP)

(72) Inventors: Kensuke WAGATA, Tokyo (JP); Karen STEPHEN, Tokyo (JP); Yuki KOSAKA, Tokyo (JP)

(73) Assignee: NEC Corporation, Tokyo (JP)

(21) Appl. No.: 19/347,946

(22) Filed: Oct. 2, 2025

(30) Foreign Application Priority Data
Oct. 15, 2024 (JP) 2024-179924

(51) Int. Cl. A63B 24/00; A63B 71/06

(52) U.S. Cl. CPC A63B 24/0062; A63B 24/0006; A63B 71/0622; A63B 2024/0065; A63B 2220/806

(57) ABSTRACT

An exercise assistance device (1) refers to instruction content for a target user who is performing an exercise in an instructed environment and selects an erroneous motion class related to the instruction content, (2) refers to a video indicating a motion of the target user who is performing the exercise in an uninstructed environment and selects an erroneous motion class related to the motion from among the erroneous motion classes selected by a first selection unit, and (3) refers to the erroneous motion class selected by a second selection unit and generates advice to be presented to the target user who performs the exercise in the uninstructed environment. Furthermore, this exercise assistance device can assist in decision making regarding the exercise of the target user by advice.

### INCORPORATION BY REFERENCE

This application is based upon and claims the benefit of priority from Japanese patent application No. 2024-179924, filed on Oct. 15, 2024, the disclosure of which is incorporated herein in its entirety by reference.

### TECHNICAL FIELD

The present disclosure relates to an exercise assistance technology.

### BACKGROUND ART

Techniques for assisting in exercise for rehabilitation are widely used. WO 2024/085095 A1 discloses a technique for providing prescription content including a training video, a training explanation, a motion analysis definition, and the like to a patient according to an instruction of a medical person.

### SUMMARY

Exercise for rehabilitation is not enough to be performed only in an environment (for example, a medical institution) where a coach (for example, physical therapists) can give instruction, but is required to be performed in an environment (for example, the patient's home) where a coach cannot make instruction. However, in a case where the user (for example, a patient) performs exercise in an environment without instruction, a sufficient effect may not be obtained due to collapse of the pose or the like.

According to the technique described in WO 2024/085095 A1, it is possible to provide the user with prescription content including a training video, a training description, a motion analysis definition, and the like. However, even with the technique described in WO 2024/085095 A1, the user cannot grasp whether the instruction of the coach in the environment with instruction is reflected in the motion of the user in the environment without instruction. Therefore, the prescription content provided by the technique described in WO 2024/085095 A1 cannot be said to be sufficiently useful advice as advice to be provided to a user who performs exercise in an environment without instruction.

The present disclosure has been made in view of the above problems, and an example object thereof is to implement an exercise assistance technology capable of providing a more beneficial piece of advice to a user who performs exercise in an environment without instruction.

An exercise assistance device according to an example aspect of the present disclosure includes a first selection means for referring to instruction content for a target user who is performing an exercise in an instructed environment and selecting an erroneous motion class related to the instruction content from among a plurality of erroneous motion classes, a second selection means for referring to a video indicating a motion of the target user who is performing the exercise in an uninstructed environment and selecting an erroneous motion class related to the motion from among erroneous motion classes selected by the first selection means, and an advice generation means for referring to the erroneous motion class selected by the second selection means and generating advice to be presented to the target user who performs the exercise in the uninstructed environment.

An exercise assistance system according to an example aspect of the present disclosure includes a server and a terminal, wherein the server includes a first selection means for referring to instruction content for a target user who is performing an exercise in an instructed environment and selecting an erroneous motion class related to the instruction content from among a plurality of erroneous motion classes, and a tuning means for generating, by machine learning using tuning data including a video indicating a motion of the target user who is performing the exercise in the instructed environment and erroneous motion classes selected by the first selection means, an individual optimization model in which an input is a video indicating a motion of the user who is performing the exercise and an output is any of the erroneous motion classes selected by the first selection means from a general model in which an input is a video indicating a motion of the user who is performing the exercise and an output is any of the plurality of erroneous motion classes, and the terminal includes a second selection means for referring to a video indicating a motion of the target user who is performing the exercise in an uninstructed environment and selecting an erroneous motion class related to the motion from among erroneous motion classes selected by the first selection means, the second selection means selecting, as an erroneous motion class related to the motion, an erroneous motion class output from the individual optimization model when a video indicating a motion of the target user who is performing the exercise in the uninstructed environment is input to the individual optimization model, and an advice generation means for referring to the erroneous motion class selected by the second selection means and generating advice to be presented to the target user who performs the exercise in the uninstructed environment.

An exercise assistance system according to an example aspect of the present disclosure includes a server and a terminal, wherein the server includes a first selection means for referring to instruction content for a target user who is performing an exercise in an instructed environment and selecting an erroneous motion class related to the instruction content from among a plurality of erroneous motion classes, and the terminal includes a tuning means for generating, by machine learning using tuning data including a video indicating a motion of the target user who is performing the exercise in the instructed environment and erroneous motion classes selected by the first selection means, an individual optimization model in which an input is a video indicating a motion of the user who is performing the exercise and an output is any of the erroneous motion classes selected by the first selection means from a general model in which an input is a video indicating a motion of the user who is performing the exercise and an output is any of the plurality of erroneous motion classes, a second selection means for referring to a video indicating a motion of the target user who is performing the exercise in an uninstructed environment and selecting an erroneous motion class related to the motion from among erroneous motion classes selected by the first selection means, the second selection means selecting, as an erroneous motion class related to the motion, an erroneous motion class output from the individual optimization model when a video indicating a motion of the target user who is performing the exercise in the uninstructed environment is input to the individual optimization model, and an advice generation means for referring to the erroneous motion class selected by the second selection means and generating advice to be presented to the target user who performs the exercise in the uninstructed environment.

An exercise assistance method according to an example aspect of the present disclosure includes a first selection process of at least one processor referring to instruction content for a target user who is performing an exercise in an instructed environment and selecting an erroneous motion class related to the instruction content from among a plurality of erroneous motion classes, a second selection process of the at least one processor referring to a video indicating a motion of the target user who is performing the exercise in an uninstructed environment and selecting an erroneous motion class related to the motion from among the erroneous motion classes selected by the first selection process, and an advice generation process of the at least one processor referring to the erroneous motion class selected by the second selection process and generating advice to be presented to the target user who performs the exercise in the uninstructed environment.

### BRIEF DESCRIPTION OF DRAWINGS

FIG. 1 is a block diagram illustrating a configuration of the exercise assistance device according to the present disclosure;

FIG. 2 is a flowchart illustrating a flow of the exercise assistance method according to the present disclosure;

FIG. 3 is a diagram illustrating a specific example of instruction content referred to by a first selection unit of the exercise assistance device illustrated in FIG. 1;

FIG. 4 is a diagram illustrating a specific example of an erroneous motion class selectable by the first selection unit of the exercise assistance device illustrated in FIG. 1;

FIG. 5 is a diagram illustrating a specific example of instruction content generated by an advice generation unit of the exercise assistance device illustrated in FIG. 1;

FIG. 6 is a block diagram illustrating a configuration example of a second selection unit of the exercise assistance device illustrated in FIG. 1;

FIG. 7 is a block diagram illustrating a configuration of the exercise assistance device according to the present disclosure;

The upper part of FIG. 8 is a diagram illustrating a specific example of the instructed environment video referred to by a first video division unit of the exercise assistance device illustrated in FIG. 7; The middle part is a diagram illustrating a specific example of the exercise video generated by the first video division unit of the exercise assistance device illustrated in FIG. 7; The lower part is a diagram illustrating a specific example of the unit exercise video generated by a second video division unit of the exercise assistance device illustrated in FIG. 7;

FIG. 9 is a diagram illustrating a specific example of instruction content generated by a voice analysis unit of the exercise assistance device illustrated in FIG. 7;

FIG. 10 is a block diagram illustrating a configuration of the exercise assistance device according to the present disclosure;

FIG. 11 is a diagram illustrating a specific example of a summary sentence generated by a summary/extraction unit of the exercise assistance device illustrated in FIG. 10;

FIG. 12 is a diagram illustrating a specific example of an explanatory video generated by an explanatory video generation unit of the exercise assistance device illustrated in FIG. 10;

FIG. 13 is a diagram illustrating a specific example of multimedia content generated by a synthesis unit of the exercise assistance device illustrated in FIG. 10;

FIG. 14 is a block diagram illustrating a configuration example of the exercise assistance system according to the present disclosure;

FIG. 15 is a block diagram illustrating a modified example of the exercise assistance system illustrated in FIG. 14;

FIG. 16 is a block diagram illustrating a modified example of the exercise assistance system illustrated in FIG. 14; and

FIG. 17 is a block diagram illustrating a configuration of a computer that operates as the exercise assistance device according to the present disclosure.

### EXAMPLE EMBODIMENT

Hereinafter, example embodiments of the present invention will be described. However, the present invention is not limited to the exemplary example embodiments to be described below, and various modifications can be made within the scope described in the claims. For example, example embodiments obtained by appropriately combining techniques (some or all of things or methods) used in the following exemplary example embodiments can also be included in the scope of the present invention. Example embodiments obtained by appropriately omitting some of the techniques used in the following exemplary example embodiments can also be included in the scope of the present invention. Effects mentioned in the following exemplary example embodiments are examples of effects expected in the exemplary example embodiments, and do not define extensions of the present invention. That is, example embodiments that do not achieve the effects mentioned in the following exemplary example embodiments can also be included in the scope of the present invention.

### Description of Terms

In the present disclosure, exercise performed for healthcare (recovery, maintenance, improvement, or the like of motion function) is referred to as “exercise”. A person who performs exercise (for example, a patient) is referred to as a “target user”, and a person who instructs the target user to perform exercise (for example, a medical worker such as a physical therapist) is referred to as a “coach”.

In the present disclosure, an environment in which the target user performs exercise while being instructed by the coach is referred to as an “instructed environment”. The instructed environment includes both an offline instructed environment in which the instruction is received offline and an online instructed environment in which the instruction is received online. Examples of the offline instructed environment include a medical institution and a gym. An example of the offline instructed environment includes a web meeting.

In the present disclosure, an environment in which the target user performs exercise without being instructed by the coach is referred to as an “uninstructed environment”. The uninstructed environment can also be referred to as an environment in which self-training is performed. An example of the uninstructed environment includes the home of the target user.

In the present disclosure, a case is mainly assumed in which after the target user performs exercise in the instructed environment, the target user performs exercise in the uninstructed environment. A technique for assisting in exercise in an uninstructed environment using information obtained from exercise in an instructed environment will be described.

### First Exemplary Example Embodiment

The first exemplary example embodiment that is an example of an example embodiment of the present invention will be described in detail with reference to the drawings. The present exemplary example embodiment is a basic form of each exemplary example embodiment to be described below. An application range of each technique used in the present exemplary example embodiment is not limited to the present exemplary example embodiment. That is, each technique used in the present exemplary example embodiment can also be used in the other exemplary example embodiments included in the present disclosure within a range in which no particular technical problem occurs. Each technique illustrated in the drawings referred to for describing the present exemplary example embodiment can also be used in the other exemplary example embodiments included in the present disclosure within a range in which no particular technical problem occurs.

### Configuration of Exercise Assistance Device

A configuration of an exercise assistance device 1 will be described with reference to FIG. 1. FIG. 1 is a block diagram illustrating a configuration of the exercise assistance device 1.

The exercise assistance device 1 is a device for assisting in exercise in an uninstructed environment. As illustrated in FIG. 1, the exercise assistance device 1 includes a first selection unit 11, a second selection unit 12, and an advice generation unit 13.

The first selection unit 11 is a means for referring to the instruction content for the target user TU who is performing exercise E in the instructed environment, and selecting the erroneous motion class related to the instruction content from a plurality of predetermined erroneous motion classes C1, C2, . . . , and Cn. Each erroneous motion class Ci is related to a typical erroneous motion that frequently occurs in the exercise E. n is a natural number equal to or more than 2, and i is a natural number equal to or more than 1 and equal to or less than n. Hereinafter, the erroneous motion classes selected by the first selection unit 11 are referred to as erroneous motion classes C′1, C′2, . . . , and C′m. m is a natural number equal to or more than 1 and equal to or less than n. The erroneous motion classes C1, C2, . . . , and Cn may include a class indicating that the erroneous motion class does not correspond to a typical erroneous motion.

For example, the first selection unit 11 uses a model M1 machine trained in such a way as to output the erroneous motion class having the highest probability (likelihood) related to the instruction content among the predetermined erroneous motion classes C1, C2, . . . , and Cn when (text or voice indicating) the instruction content for a target user TU who is performing the exercise E is input. In this case, the first selection unit 11 inputs the instruction content for the target user TU who is performing the exercise E in the instructed environment to the model M1, and selects the erroneous motion class output from the model M1 at this time as the erroneous motion class related to the instruction content.

Alternatively, the first selection unit 11 uses a keyword associated with each of the predetermined erroneous motion classes C1, C2, . . . , and Cn. In this case, the first selection unit 11 selects the erroneous motion class associated with the keyword matching (the text representing) the instruction content for the target user TU who is performing the exercise E in the instructed environment as the erroneous motion class related to the instruction content.

The number of erroneous motion classes selected by the first selection unit 11 for one set of instruction content is one. However, in one exercise E, the target user TU may repeatedly perform the unit exercise, and the coach may instruct the target user for each unit exercise. In this case, the first selection unit 11 can select the erroneous motion class related to each unit exercise with reference to the instruction content for each unit exercise. This is the reason why there may be a plurality of erroneous motion classes C′1, C′2, . . . , and C′m selected by the first selection unit 11.

The second selection unit 12 is a means for referring to the video indicating the motion of the target user TU who is performing the exercise E in the uninstructed environment and selecting the erroneous motion class related to the motion from the single erroneous motion class or plurality of erroneous motion classes C′1, C′2, . . . , and C′m selected by the first selection unit 11. Hereinafter, the erroneous motion classes selected by the second selection unit 12 are referred to as erroneous motion classes C″1, C″2, . . . , and C″k. k is a natural number equal to or more than 1 and equal to or less than m.

For example, the second selection unit 12 uses a model M2 machine trained in such a way as to output the erroneous motion class having the highest probability (likelihood) related to the motion among the erroneous motion classes C′1, C′2, . . . , and C′m selected by the first selection unit 11 when a video indicating the motion of the target user TU who is performing the exercise E is input. In this case, the second selection unit 12 inputs a video indicating each motion of the target user TU who is performing the exercise E in the instructed environment to the model M2, and selects the erroneous motion class output from the model M2 at this time as the erroneous motion class related to the motion. The model M2 used by the second selection unit 12 will be described later as an individual optimization model M2.

The number of erroneous motion classes selected by second selection unit 12 for the video indicating one motion is one. However, in one exercise E, the target user TU may repeatedly perform the unit exercise. Therefore, the second selection unit 12 can select the erroneous motion class related to each unit exercise with reference to the video indicating the motion of the target user TU in each unit exercise. This is the reason why there may be a plurality of erroneous motion classes C″1, C″2, . . . , and C″k selected by the second selection unit 12.

The advice generation unit 13 is a means for referring to the single erroneous motion class or the plurality of erroneous motion classes C″1, C″2, . . . , and C″k selected by the second selection unit 12 and generating advice to be presented to the target user TU who performs the exercise E in the uninstructed environment. As an example, the advice generation unit 13 generates advice pointing out the content of the erroneous motion classes C″1, C″2, . . . , and C″k selected by the second selection unit 12 as a problem.

The advice generation unit 13 may be configured to generate advice with reference to the instruction content for the target user TU who is performing the exercise E in the instructed environment, in addition to the erroneous motion classes C″1, C″2, . . . , and C″k selected by the second selection unit 12.

The advice generated by the advice generation unit 13 is displayed, for example, on the display of the mobile terminal of the target user TU. In this case, the advice generated by the advice generation unit 13 is transmitted to the mobile terminal of the target user TU via the network.

### Flow of Exercise Assistance Method

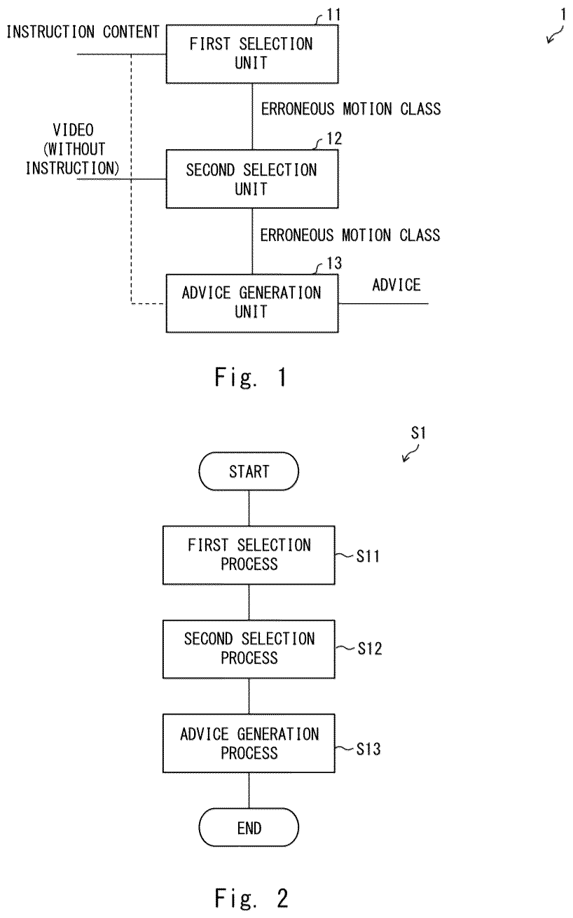

A flow of an exercise assistance method S1 will be described with reference to FIG. 2. FIG. 2 is a flowchart illustrating a flow of the exercise assistance method S1.

The exercise assistance method S1 is a method of assisting in exercise in an uninstructed environment. As illustrated in FIG. 2, the exercise assistance method S1 includes a first selection process S11, a second selection process S12, and an advice generation process S13. The exercise assistance method S1 is executed by the exercise assistance device 1, for example.

The first selection process S11 is a process of referring to the instruction content for the target user TU who is performing the exercise E in the instructed environment and selecting the erroneous motion class related to the instruction content from a plurality of predetermined erroneous motion classes C1, C2, . . . , and Cn. Each erroneous motion class Ci represents a typical erroneous motion that frequently occurs in the exercise E. n is a natural number equal to or more than 2, and i is a natural number equal to or more than 1 and equal to or less than n. Hereinafter, the erroneous motion classes selected in the first selection process S11 are referred to as erroneous motion classes C′1, C′2, . . . , and C′m. m is a natural number equal to or more than 1 and equal to or less than n. The erroneous motion classes C1, C2, . . . , and Cn may include a class indicating that the erroneous motion class does not correspond to a typical erroneous motion. The first selection process S11 is executed by the first selection unit 11 of the exercise assistance device 1, for example.

In the first selection process S11, for example, when (text or voice indicating) the instruction content for the target user TU is input, the model M1 machine trained in such a way as to output the erroneous motion class having the highest probability (likelihood) related to the instruction content among the predetermined erroneous motion classes C1, C2, . . . , and Cn is used. In this case, in the first selection process S11, the instruction content for the target user TU who is performing the exercise E in the instructed environment is input to the model M1, and the erroneous motion class output from the model M1 at this time is selected as the erroneous motion class related to the instruction content.

Alternatively, in the first selection unit 11, a keyword associated with each of the predetermined erroneous motion classes C1, C2, . . . , and Cn is used. In this case, in the first selection process S11, the erroneous motion class associated with the keyword matching (the text representing) the instruction content for the target user TU who is performing the exercise E in the instructed environment is selected as the erroneous motion class related to the instruction content.

The number of erroneous motion classes selected in the first selection process S11 for one set of instruction content is one. However, in one exercise E, the target user TU may repeatedly perform the unit exercise, and the coach may instruct the target user for each unit exercise. In this case, in the first selection process S11, the erroneous motion class related to each unit exercise can be selected with reference to the instruction content for each unit exercise. This is the reason why there may be a plurality of erroneous motion classes C′1, C′2, . . . , and C′m selected in the first selection process S11.

The second selection process S12 is a process of referring to the video indicating the motion of the target user TU who is performing the exercise E in the uninstructed environment and selecting the erroneous motion class related to the motion from the single erroneous motion class or plurality of erroneous motion classes C′1, C′2, . . . , and C′m selected in the first selection process S11. Hereinafter, the erroneous motion classes selected in the second selection process S12 are referred to as erroneous motion classes C″1, C″2, . . . , and C″k. k is a natural number equal to or more than 1 and equal to or less than m. The second selection process S12 is executed by the second selection unit 12 of the exercise assistance device 1, for example.

In the second selection process S12, for example, the model M2 machine trained in such a way as to output the erroneous motion class having the highest probability (likelihood) related to the motion among the erroneous motion classes C′1, C′2, . . . , and C′m selected in the first selection process S11 when the video indicating the motion of the target user TU is input, is used. In this case, in the second selection process S12, the video indicating the motion of the target user TU who is performing the exercise E in the instructed environment is input to the model M2, and the erroneous motion class output from the model M2 at this time is selected as the erroneous motion class related to the motion. The model M2 used in the second selection process S12 will be described later as an individual optimization model M2.

The number of erroneous motion classes selected in second selection process S12 for the video indicating one motion is one. However, in one exercise E, the target user TU may repeatedly perform the unit exercise. Therefore, in the second selection process S12, the erroneous motion class related to each unit exercise can be selected with reference to the video indicating the motion of the target user TU in each unit exercise. This is the reason why there may be a plurality of erroneous motion classes C″1, C″2 , . . . , and C″k selected in the second selection process S12.

The advice generation process S13 is a process of referring to the single erroneous motion class or the plurality of erroneous motion classes C″1, C″2, . . . , and C″k selected in the second selection process S12 and generating advice to be presented to the target user TU who performs the exercise E in the uninstructed environment. As an example, in the advice generation process S13, advice pointing out the content of the erroneous motion classes C″1, C″2, . . . , and C″k selected in the second selection process S12 as a problem is generated.

In the advice generation process S13, the advice may be generated with reference to the instruction content for the target user TU who is performing the exercise E in the instructed environment in addition to the erroneous motion classes C″1, C″2, . . . , and C″k selected in the second selection process S12.

The advice generated by the advice generation process S13 is displayed, for example, on the display of the mobile terminal of the target user TU. In this case, the advice generated in the advice generation process S13 is transmitted to the mobile terminal of the target user TU via the network.

### Effects of Exercise Assistance Device and Exercise Assistance Method

As described above, according to the exercise assistance device 1 or the exercise assistance method S1, as the advice to be presented to the target user TU who performs the exercise E in the uninstructed environment, the advice according to the instruction content for the target user TU who performs the exercise E in the instructed environment can be generated.

Moreover, the advice generated by the exercise assistance method S1 is advice generated according to the erroneous motion classes C″1, C″2, . . . , and C″k particularly selected with reference to the video indicating the motion of the target user TU performing the exercise E in the uninstructed environment among the erroneous motion classes C′1, C′2, . . . , and C′m selected with reference to the instruction content for the target user TU performing the exercise E in the instructed environment. That is, the advice is related to the erroneous motion caused when performing the exercise E particularly in the uninstructed environment among the erroneous motions for which the user is instructed when performing the exercise E in the instructed environment.

Therefore, according to the exercise assistance device 1 or the exercise assistance method S1, as the advice to be presented to the target user TU who performs the exercise E in the uninstructed environment, it is possible to generate advice highly beneficial to the target user TU, the advice being focused on the point the target user TU should pay attention to.

With this advice, it is possible to assist in decision making by the target user such as improving an erroneous motion in exercise.

### Specific Examples of Instruction Content, Erroneous Motion Class, and Advice

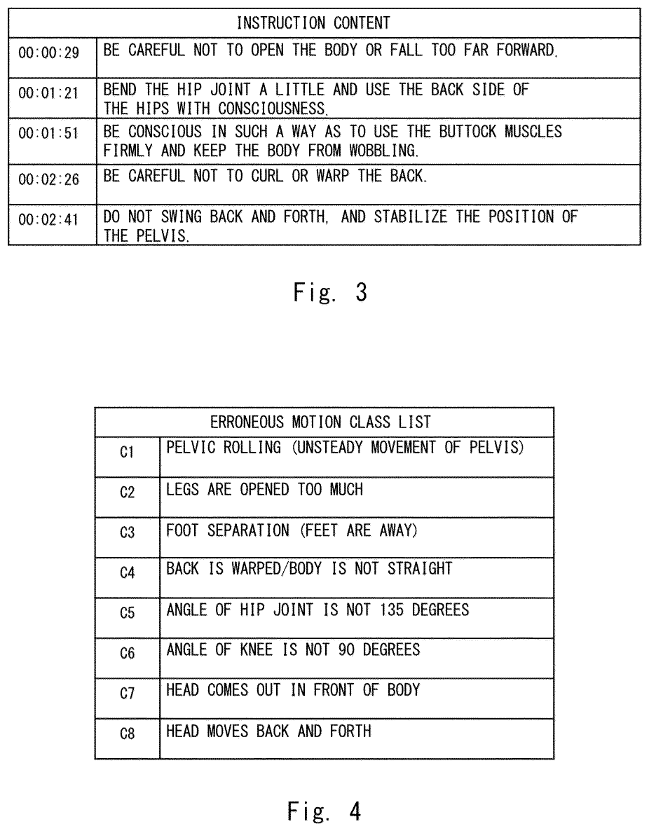

Specific examples of the instruction content referred to by the first selection unit 11, the erroneous motion class selected by the first selection unit 11, and the advice generated by the advice generation unit 13 will be described with reference to FIG. 3 to 5. “Clamshell” is considered as an example of the exercise E.

The instruction content referred to by the first selection unit 11 is, for example, part of the utterance content of the coach in the instructed environment. The utterance content of the coach in the instructed environment includes (1) utterance content corresponding to “explanation” for the target user TU before performing each unit exercise constituting the exercise E, and (2) utterance content corresponding to “instruction” (feedback) for the target user TU during or after execution of each unit exercise constituting the exercise E. The instruction content referred to by the first selection unit 11 is utterance content corresponding to “instruction” for the target user TU during or after execution of each unit exercise constituting the exercise E, of the utterance content of the coach in the instructed environment.

FIG. 3 is a diagram illustrating a specific example of the instruction content referred to by the first selection unit 11. FIG. 3 illustrates five sets of instruction content in one exercise E. Each instruction content is provided with a time stamp indicating the time when the instruction is provided.

The first instruction content is utterance content “be careful not to open the body or fall too far forward” of the coach 29 seconds after the start of the exercise. The second instruction content is utterance content “bend the hip joint a little and use the back side of the hips with consciousness” of the coach 1 minute and 21 seconds after the start of the exercise. The third instruction content is utterance content “be conscious in such a way as to use the buttock muscles firmly and keep the body from wobbling” of the coach 1 minute and 51 seconds after the start of the exercise. The fourth instruction content is the utterance content “be careful not to curl or warp the back” of the coach 2 minutes and 26 seconds after the start of the exercise. The fifth instruction content is the utterance content “do not swing back and forth, and stabilize the position of the pelvis” of the coach 2 minutes and 41 seconds after the start of the exercise.

FIG. 4 is a diagram illustrating a specific example of the erroneous motion class selectable by the first selection unit 11. FIG. 4 illustrates eight erroneous motion classes C1 to C8. Each of these erroneous motion classes C1 to C8 represents a typical erroneous motion that frequently occurs in the exercise E.

The model M1 used by the first selection unit 11 is machine trained in such a way as to output the erroneous motion class having the highest probability (likelihood) related to the instruction content among the erroneous motion classes C1 to C8 illustrated in FIG. 4 when (text or voice indicating) the instruction content for the target user TU is input.

Among the instruction content illustrated in FIG. 3, a first instruction content “be careful not to open the body or fall too far forward” is typical instruction content pointed out by the coach when the erroneous motion “pelvis rolling” is observed. Therefore, when the first instruction content “be careful not to open the body or fall too far forward” is input, the model M1 used by the first selection unit 11 outputs the erroneous motion class C1 representing the erroneous motion “pelvis rolling”.

Among the instruction content illustrated in FIG. 3, the second instruction content “bend the hip joint a little and use the back side of the hips with consciousness” is typical instruction content pointed out by the coach when the erroneous motion “the angle of the hip joint is not 135°” is observed. Therefore, when the second instruction content “bend the hip joint a little and use the back side of the hips with consciousness” is input, the model M1 used by the first selection unit 11 outputs the erroneous motion class C5 representing the erroneous motion “the angle of the hip joint is not 135°”.

The third instruction content “be conscious in such a way as to use the buttock muscles firmly and keep the body from wobbling” among the instruction content illustrated in FIG. 3 is a typical instruction content pointed out by the coach when the erroneous motion “pelvis rolling” is observed, as in the first instruction content.

Therefore, when the third instruction content “be conscious in such a way as to use the buttock muscles firmly and keep the body from wobbling” is input, the model M1 used by the first selection unit 11 outputs the erroneous motion class C1 representing the erroneous motion “pelvis rolling”.

Among the instruction content illustrated in FIG. 3, the fourth instruction content “be careful not to curl or warp the back” is a typical instruction content pointed out by the coach when the erroneous motion “the back is warped/the body is not straight” is observed. Therefore, when the fourth instruction content “be careful not to curl or warp the back” is input, the model M1 used by the first selection unit 11 outputs the erroneous motion class C4 representing the erroneous motion “the back is warped/the body is not straight”.

Among the instruction content illustrated in FIG. 3, the fifth instruction content “Do not swing back and forth, and stabilize the position of the pelvis” is a typical instruction content pointed out by the coach when the erroneous motion “pelvis rolling” is observed, as in the first instruction content and the third instruction content.

When the fifth instruction content “Do not swing back and forth, and stabilize the position of the pelvis” is input, the model M1 used by the first selection unit 11 outputs the erroneous motion class C1 representing the erroneous motion “pelvis rolling”.

As described above, in a case where the instruction content referred to by the first selection unit 11 in one exercise E is the five sets of instruction content illustrated in FIG. 3, the first selection unit 11 selects the three erroneous motion classes C1, C4, and C5. Therefore, in this case, the second selection unit 12 refers to the video indicating the motion of the target user TU who is performing the exercise E in the uninstructed environment, and selects the erroneous motion class related to the motion among the three erroneous motion classes C1, C4, and C5 selected by the first selection unit 11.

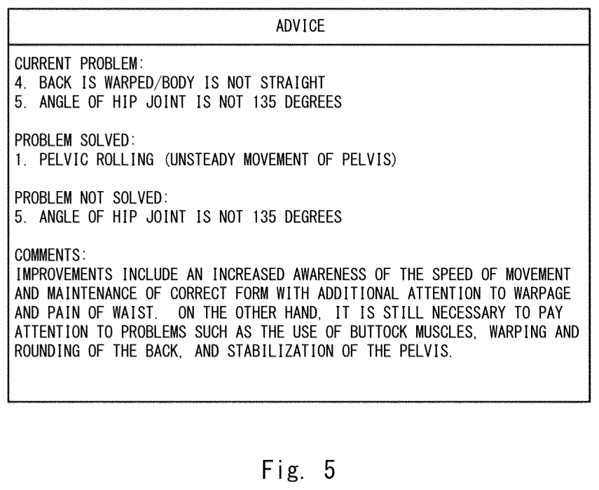

FIG. 5 is a diagram illustrating a specific example of advice generated by the advice generation unit 13. The advice illustrated in FIG. 5 is an example of advice generated in a case where the erroneous motion classes selected by the second selection unit 12 for the current exercise E are the erroneous motion classes C4 and C5, and the erroneous motion classes selected by the second selection unit 12 for the previous exercise E are the erroneous motion classes C1 and C5.

In the advice illustrated in FIG. 5, the content of the erroneous motion classes C4 and C5 selected by the second selection unit 12 for the current exercise E is pointed out as a problem (see “current problem” in FIG. 5). In the advice illustrated in FIG. 5, the content of the erroneous motion class C1 that the second selection unit 12 did not select for the current exercise E among the erroneous motion classes C1 and C5 selected by the second selection unit 12 with respect to the previous exercise E is pointed out as a problem solved (see “problem solved” in FIG. 5). In the advice illustrated in FIG. 5, the content of the erroneous motion class C5 selected by the second selection unit 12 for the current exercise E among the erroneous motion classes C1 and C5 selected by the second selection unit 12 for the previous exercise E is pointed out as a problem that was not solved (see “problem not solved” in FIG. 5).

Further, the advice illustrated in FIG. 5 includes a comment “Improvements include an increased awareness of the speed of movement and maintenance of correct form with additional attention to warpage and pain of waist” related to the erroneous motion class C1 representing an improved erroneous motion and a comment “On the other hand, it is still necessary to pay attention to problems such as the use of buttock muscles, warping and rounding of the back, and stabilization of the pelvis” related to the erroneous motion class C5 representing an unimproved erroneous motion. These comments can be generated with reference to the instruction content for the target user TU who is performing the exercise E in the instructed environment, for example.

### Configuration Example of Second Selection Unit

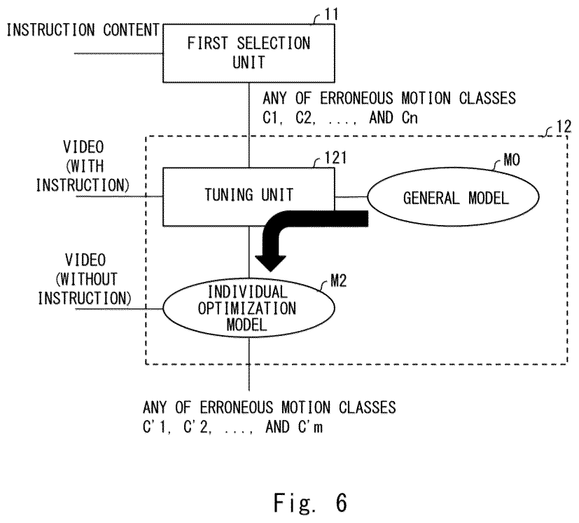

A configuration example of the second selection unit 12 included in the exercise assistance device 1 will be described with reference to FIG. 6. FIG. 6 is a block diagram illustrating a configuration example of the second selection unit 12.

As illustrated in FIG. 6, the second selection unit 12 can include a tuning unit 121, a general model M0, and an individual optimization model M2.

In the present specific example, it is assumed that a video indicating a certain motion of the target user TU who is performing the exercise E in the instructed environment and the instruction content for the motion are given as a set. The first selection unit 11 selects the erroneous motion class related to the motion of the target user TU represented by the videos constituting the set with reference to the instruction content constituting the set.

The general model M0 is a model that is machine trained in advance in such a way as to output an erroneous motion class having the highest probability (likelihood) related to the motion among predetermined erroneous motion classes C1, C2, . . . , and Cn when a video indicating the motion of the user is input. The tuning unit 121 generates the individual optimization model M2 from the general model M0 by machine learning (relearning or additional learning) using the tuning data in which the video constituting the above set and the erroneous motion class selected by the first selection unit 11 with reference to the instruction content constituting the above set are combined. The individual optimization model M2 outputs the erroneous motion class having the highest probability (likelihood) related to the motion among the erroneous motion classes C′1, C′2, . . . , and C′m selected by the first selection unit 11 when a video indicating the motion of the target user TU is input.

The second selection unit 12 inputs a video indicating the motion of the target user TU who is performing the exercise E in the uninstructed environment to the individual optimization model M2, and selects the erroneous motion class output from the individual optimization model M2 at this time as the erroneous motion class related to the motion.

With the configuration of the second selection unit 12 as described above, the erroneous motion class related to the motion of the target user TU can be appropriately selected using the individual optimization model M2 optimized for the target user TU.

### Second Exemplary Example Embodiment

A second exemplary example embodiment that is an example embodiment of the present invention will be described in detail with reference to the drawings. Components having the same functions as the components described in the above-described exemplary example embodiment will be denoted by the same reference numerals, and the description thereof will be appropriately omitted. An application range of each technique used in the present exemplary example embodiment is not limited to the present exemplary example embodiment. That is, each technique used in the present exemplary example embodiment can also be used in the other exemplary example embodiments included in the present disclosure within a range in which no particular technical problem occurs. Each technique illustrated in each of the drawings referred to for describing the present exemplary example embodiment can be employed in the other exemplary example embodiments included in the present disclosure within the scope in which no particular technical problem occurs.

### Configuration of Exercise Assistance Device

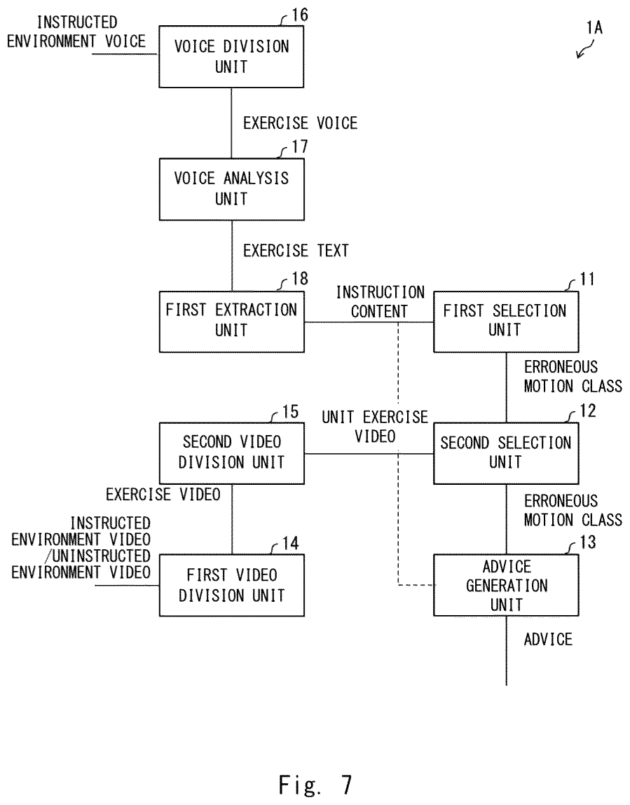

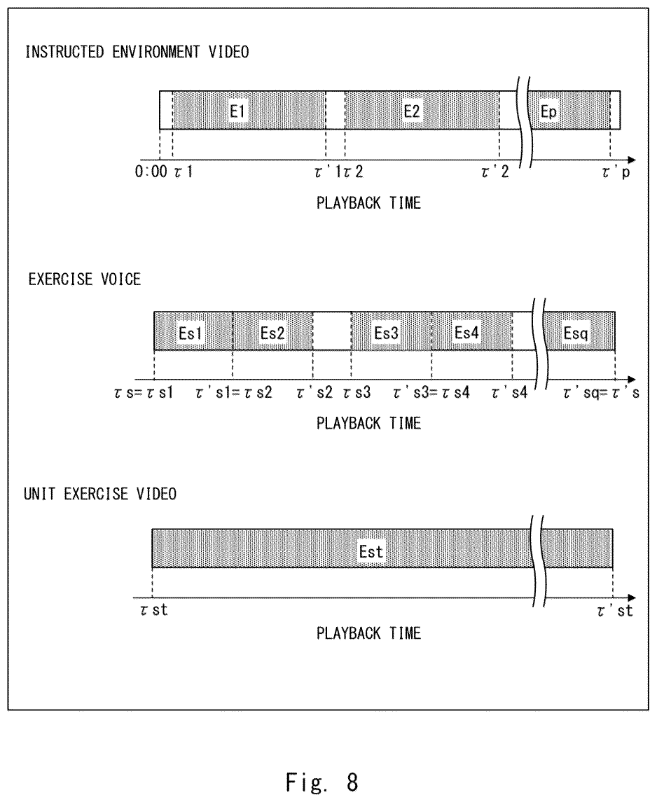

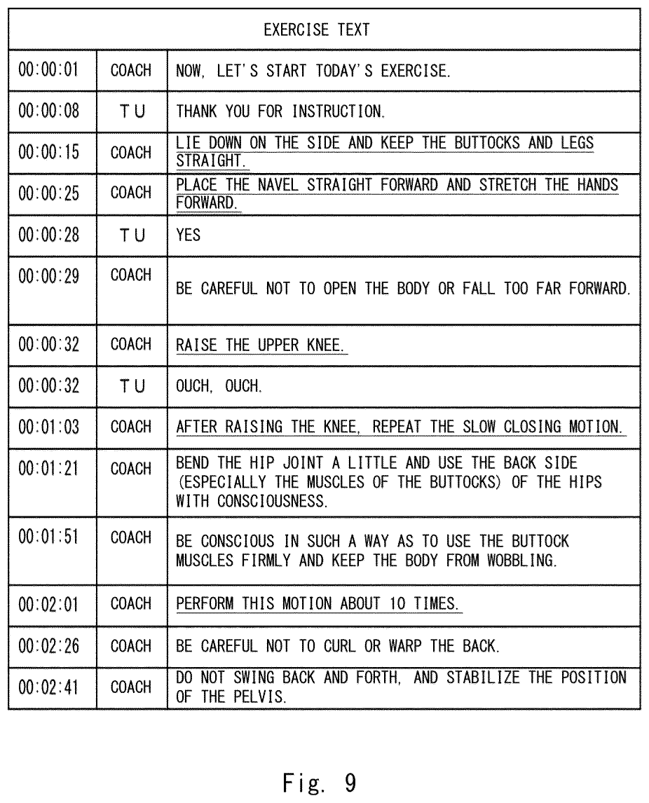

An exercise assistance device 1A will be described with reference to FIGS. 7, 8, and 9. FIG. 7 is a block diagram illustrating a configuration of the exercise assistance device 1A. FIG. 8 is a diagram illustrating an uninstructed environment video, an exercise video, and a unit exercise video used in the exercise assistance device 1A. FIG. 9 is a diagram illustrating a configuration of an exercise text used in the exercise assistance device 1A.

The exercise assistance device 1A is an exercise assistance device optimized in a case where the target user TU sequentially performs a plurality of exercises E1, E2, . . . , and Ep in an instructed environment and an uninstructed environment. The s-th exercise that the target user TU performs will be hereinafter referred to as an exercise Es. p is a natural number of 1 or more, and s is a natural number equal to or more than 1 and equal to or less than p. It is assumed that each exercise Es includes a plurality of unit exercises Es1, Es2, . . . , and Esqₛ. The t-th unit exercise performed by the target user TU in each exercise Es will be hereinafter referred to as a unit exercise Est. qₛ is a natural number of 1 or more determined according to s, and t is a natural number equal to or more than 1 and equal to or less than qₛ. The unit exercise Est may be referred to as a “rep”.

The exercise assistance device 1A refers to the following instructed environment video, instructed environment voice, and uninstructed environment video. The following recording of the instructed environment video and the following recording of the instructed environment voice are performed simultaneously in the instructed environment.

Instructed environment video: A video that is recorded in the instructed environment, and which represents the motion of the target user TU who sequentially performs the exercises E1, E2, . . . , and Ep. The recording of the instructed environment video is performed, for example, in the mobile terminal of the target user TU. In this case, the exercise assistance device 1A acquires the instructed environment video from the mobile terminal of the target user TU via the network.

Instructed environment voice: A voice that is recorded in an instructed environment, and which represents utterance content of the target user TU who sequentially performs the exercises E1, E2, . . . , and Ep and the coach who instructs the target user TU. The instructed environment voice is recorded, for example, in the mobile terminal of the coach. In this case, the exercise assistance device 1A acquires the instructed environment voice from the mobile terminal of the coach via the network.

Uninstructed environment video: A video that is recorded in the uninstructed environment, and which represents the motion of the target user TU who sequentially performs the exercises E1, E2, . . . , and Ep. The uninstructed environment video is recorded, for example, in the mobile terminal of the target user TU. In this case, the exercise assistance device 1A acquires the uninstructed environment video from the mobile terminal of the target user TU via the network.

As illustrated in FIG. 7, the exercise assistance device 1A includes a first selection unit 11, a second selection unit 12, an advice generation unit 13, a first video division unit 14, a second video division unit 15, a voice division unit 16, a voice analysis unit 17, and an extraction unit 18.

The first selection unit 11, the second selection unit 12, and the advice generation unit 13 included in the exercise assistance device 1A function as in the first selection unit 11, the second selection unit 12, and the advice generation unit 13 included in the advice support device 1 illustrated in FIG. 1, respectively. Hereinafter, the functions of the first video division unit 14, the second video division unit 15, the voice division unit 16, the voice analysis unit 17, and the extraction unit 18 included in the exercise assistance device 1A will be described.

The first video division unit 14 is a means for dividing the instructed environment video recorded in the instructed environment into the exercise videos related to the respective exercises Es executed in the instructed environment. The exercise video related to the exercise Es is a video indicating the motion of the target user TU who is performing the exercise Es in the instructed environment. The upper part of FIG. 8 illustrates an example of the instructed environment video before the division, and the middle part of FIG. 8 illustrates an example of the exercise video after the division.

Instead of the first video division unit 14 that divides the instructed environment video into the exercise videos related to the respective exercises Es, an identification unit that identifies the start time τs and the end time τ's of the exercises Es in the instructed environment video may be used.

The second video division unit 15 is a means for dividing the exercise video related to each exercise Es obtained by the first video division unit 14 into unit exercise videos related to respective unit exercises Est constituting the exercise Es. The unit exercise video related to each unit exercise Est is a video indicating the motion of the target user TU who is performing the unit exercise Est in the instructed environment. The middle part of FIG. 8 illustrates an example of the exercise video before the division, and the lower part of FIG. 8 illustrates an example of the unit exercise video after the division.

In a case where the above-described identification unit is used instead of the first video division unit 14, the second video division unit 15 refers to the start time τs and the end time τ's of each exercise Es identified by the above-described identification unit, and divides the instructed environment video into unit exercise videos related to respective unit exercises Est.

The voice division unit 16 is a means for dividing the instructed environment voice recorded in the instructed environment into the exercise voices related to respective exercises Es performed in the instructed environment. The exercise voice related to each exercise Es is voice data including, as a voice, the utterance content of the target user TU who is performing the exercise Es and the utterance content of the coach who instructs the target user TU.

The voice analysis unit 17 is a means for generating an exercise text related to the exercise Es by performing voice analysis on the exercise voice related to each exercise Es obtained by the voice division unit 16. The exercise text related to each exercise Es is text data including, as text, the utterance content of the target user TU who is performing the exercise Es and the utterance content of the coach who instructs the target user TU. The voice analysis unit 17 may associate a time stamp indicating the start time of the utterance and an identifier indicating the speaker of the utterance with each utterance content. An example of an exercise text related to the exercise E1 is illustrated in FIG. 9.

In the exercise text related to each exercise Es, the utterance content of the coach who instructs the target user TU includes (1) utterance content corresponding to “explanation” for the target user TU before performing each unit exercise Est, and (2) utterance content corresponding to “instruction” (feedback) for the target user TU during or after performing each unit exercise Est. In the exercise text related to the exercise E1 illustrated in FIG. 9, five sets of underlined utterance content are utterance content corresponding to “explanation”, and five sets of utterance content described in bold are utterance content corresponding to “instruction”.

The extraction unit 18 is a means for extracting utterance content corresponding to “instruction” from the exercise text related to each exercise Es obtained by the voice analysis unit 17 as instruction content in the exercise Es. For example, the extraction unit 18 extracts five sets of utterance content described in bold letters as the instruction content in the exercise E1 from the exercise text related to the exercise E1 illustrated in FIG. 9. The instruction content illustrated in FIG. 3 is an example of the instruction content extracted by the extraction unit 18 in this manner.

In the present exemplary example embodiment, the first selection unit 11 refers to the instruction content related to each unit exercise Est obtained by the extraction unit 18 and selects the erroneous motion class related to the instruction content. As a result, for each exercise Es, the erroneous motion class related to each unit exercise Est constituting the exercise Es can be selected.

In the present example embodiment, the tuning unit 121 (see FIG. 6) of the second selection unit 12 generates tuning data by combining the unit exercise video related to each unit exercise Est constituting the exercise Es with the instruction content related to the unit exercise Est among the instruction content extracted by the extraction unit 18. The tuning unit 121 of the second selection unit 12 generates the individual optimization model from the general model M0 by machine learning (relearning or additional learning) using the tuning data. As described above, a time stamp is added to the instruction content extracted by the extraction unit 18. The tuning unit 121 of the second selection unit 12 can identify the instruction content related to each unit exercise Est by referring to the value of the time stamp.

The first video division unit 14 functions as a means for dividing the uninstructed environment video recorded in the uninstructed environment into the exercise videos related to the respective exercises Es executed in the uninstructed environment. The exercise video related to the exercise Es is a video indicating the motion of the target user TU who is performing the exercise Es in the uninstructed environment.

The second video division unit 15 functions as a means for dividing the exercise video related to each exercise Es obtained by the first video division unit 14 into unit exercise videos related to respective unit exercises Est constituting the exercise Es. The unit exercise video related to each unit exercise Est is a video indicating the motion of the target user TU who is performing the unit exercise Est in the uninstructed environment.

In the present exemplary example embodiment, the second selection unit 12 refers to the unit exercise video related to each unit exercise Est obtained by the second video division unit 15 and selects the erroneous motion class related to the unit exercise Est. As a result, for each exercise Es, the erroneous motion class related to each unit exercise Est constituting the exercise Es can be selected.

### Third Exemplary Example Embodiment

A third exemplary example embodiment that is an example of an example embodiment of the present invention will be described in detail with reference to the drawings. Components having the same functions as the components described in the above-described exemplary example embodiment will be denoted by the same reference numerals, and the description thereof will be appropriately omitted. An application range of each technique used in the present exemplary example embodiment is not limited to the present exemplary example embodiment. That is, each technique used in the present exemplary example embodiment can also be used in the other exemplary example embodiments included in the present disclosure within a range in which no particular technical problem occurs. Each technique illustrated in each of the drawings referred to for describing the present exemplary example embodiment can be employed in the other exemplary example embodiments included in the present disclosure within the scope in which no particular technical problem occurs.

### Configuration of Exercise Assistance Device

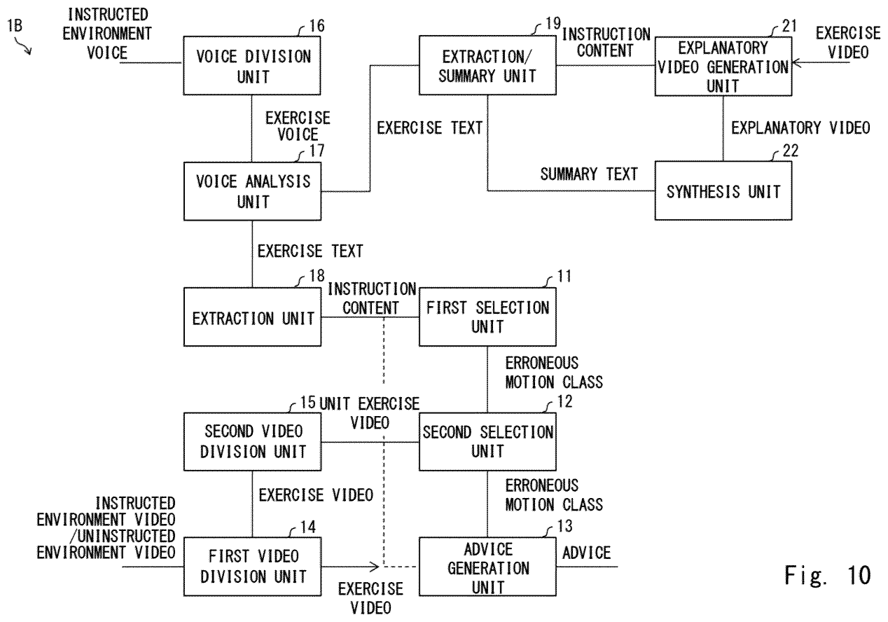

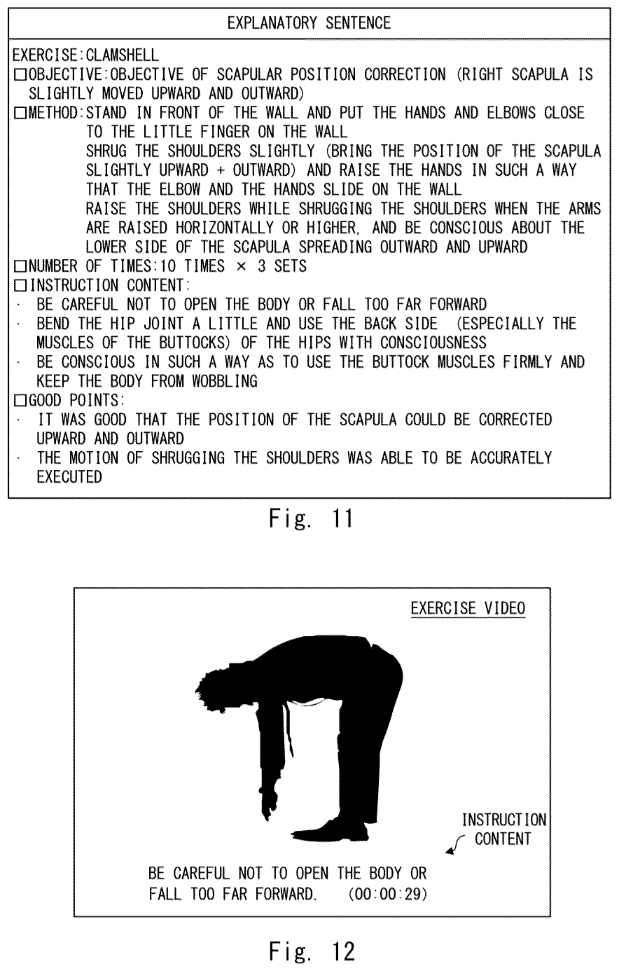

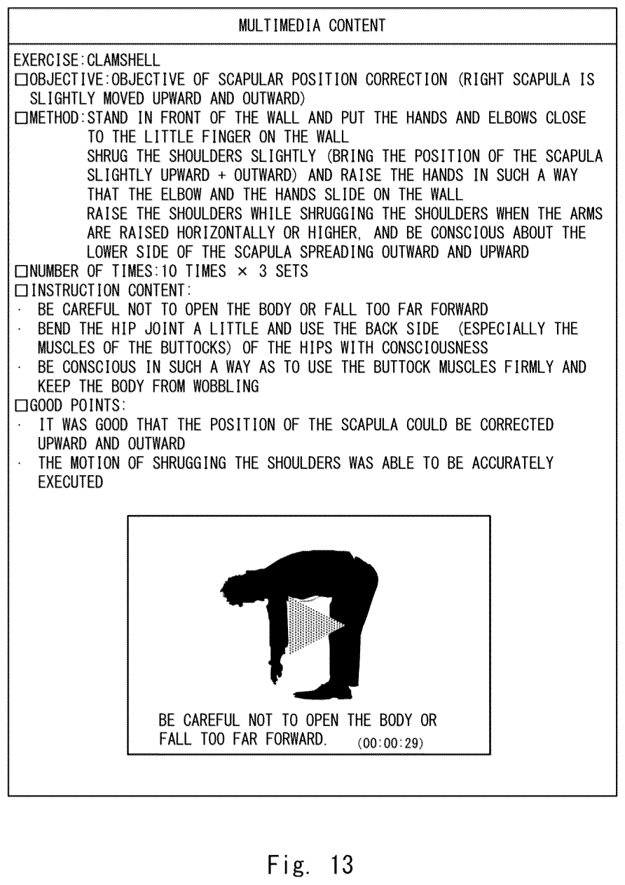

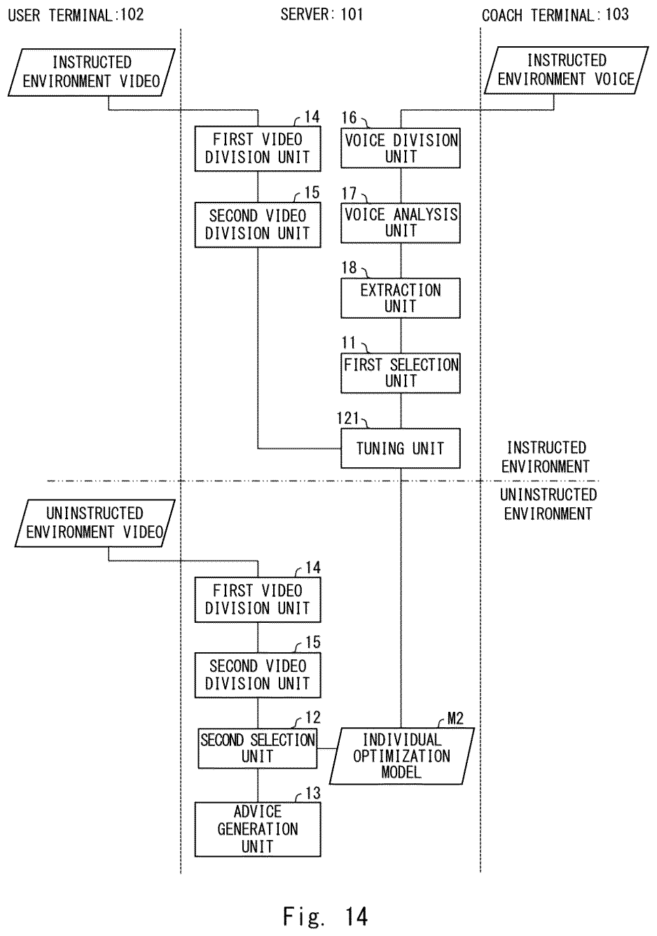

A configuration of an exercise assistance device 1B will be described with reference to FIG. 10. FIG. 10 is a block diagram illustrating a configuration of the exercise assistance device 1B. FIG. 11 is a diagram illustrating an example of an explanatory sentence generated by the exercise assistance device 1B. FIG. 12 is a diagram illustrating an example of an explanatory video generated by the exercise assistance device 1. FIG. 13 is a diagram illustrating an example of multimedia content generated by the exercise assistance device 1.

As in the exercise assistance device 1A, the exercise assistance device 1B is the exercise assistance device 1 optimized in a case where the target user TU sequentially performs a plurality of exercises E1, E2, . . . , and Ep in an instructed environment and an uninstructed environment.

As illustrated in FIG. 10, the exercise assistance device 1B includes a first selection unit 11, a second selection unit 12, an advice generation unit 13, a first video division unit 14, a second video division unit 15, a voice division unit 16, a voice analysis unit 17, an extraction unit 18, an extraction/summary unit 19, an explanatory video generation unit 21, and a synthesis unit 22.

The first selection unit 11, the second selection unit 12, the advice generation unit 13, the first video division unit 14, the second video division unit 15, the voice division unit 16, the voice analysis unit 17, and the extraction unit 18 included in the exercise assistance device 1B function as in the first selection unit 11, the second selection unit 12, the advice generation unit 13, the first video division unit 14, the second video division unit 15, the voice division unit 16, the voice analysis unit 17, and the extraction unit 18 included in the exercise assistance device 1A, respectively. Hereinafter, the functions of the extraction/summary unit 19, the explanatory video generation unit 21, and the synthesis unit 22 included in the exercise assistance device 1B will be described.

The extraction/summary unit 19 is a means for extracting utterance content corresponding to “instruction” from the exercise text related to each exercise Es obtained by the voice analysis unit 17 as instruction content in the exercise Es. The extraction/summary unit 19 is a means for generating an explanatory sentence to be presented to the target user TU who performs the exercise Es in the uninstructed environment by summarizing the exercise text related to each exercise Es obtained by the voice analysis unit 17.

The explanatory sentence generated by the extraction/summary unit 19 preferably includes, for example, at least any of the purpose, the method, and the number of times of the exercise Es. The explanatory sentence preferably includes each instruction content in the exercise Es. The explanatory sentence preferably includes points that are good and/or points that are bad in the exercise Es. FIG. 11 illustrates an example of an explanatory sentence generated by the extraction/summary unit 19.

In the present exemplary example embodiment, the first video division unit 14 functions as a means for dividing the instructed environment video recorded in the instructed environment into the exercise videos related to the respective exercises Es executed in the instructed environment.

The explanatory video generation unit 21 is a means for generating an explanatory video to be presented to the target user TU who performs the exercise Es in the uninstructed environment with reference to the exercise video related to each exercise Es obtained by the first video division unit 14 and each instruction content in the exercise Es extracted by the extraction/summary unit 19.

The explanatory video generated by the explanatory video generation unit 21 is preferably a video obtained by superimposing each instruction content in the exercise Es on the exercise video related to the exercise Es. In this case, the instruction content uttered t seconds after the start of the exercise Es is preferably superimposed on the video t seconds after the start of the exercise Es. The explanatory video generation unit 21 can generate such an explanatory video with reference to a time stamp added to each instruction content. FIG. 12 illustrates an example of the explanatory video generated by the explanatory video generation unit 21.

The synthesis unit 22 is a means for generating multimedia content to be presented to the target user TU who performs the exercise Es in the uninstructed environment by synthesizing the explanatory video generated by the explanatory video generation unit 21 and the explanatory sentence generated by the extraction/summary unit 19.

The multimedia content generated by the synthesis unit 22 is preferably multimedia content including the explanatory sentence generated by the extraction/summary unit 19 as text content and including the explanatory video generated by the explanatory video generation unit 21 as video content. The multimedia comment generated by the synthesis unit 22 may be delivered to the target user TU as an e-mail, or may be delivered to the target user as a web page. FIG. 13 illustrates an example of the multimedia comment generated by the synthesis unit.

According to the exercise assistance device 1B, the explanatory sentence generated by the extraction/summary unit 19 can be provided to the target user TU. According to the exercise assistance device 1B, the explanatory video generated by the explanatory video generation unit 21 can be provided to the target user TU. Therefore, according to the exercise assistance device 1B, information with higher usefulness for the target user TU can be provided.

### Fourth Exemplary Example Embodiment

The fourth exemplary example embodiment that is an example of an example embodiment of the present invention will be described in detail with reference to the drawings. Components having the same functions as the components described in the above-described exemplary example embodiment will be denoted by the same reference numerals, and the description thereof will be appropriately omitted. An application range of each technique used in the present exemplary example embodiment is not limited to the present exemplary example embodiment. That is, each technique used in the present exemplary example embodiment can also be used in the other exemplary example embodiments included in the present disclosure within a range in which no particular technical problem occurs. Each technique illustrated in each of the drawings referred to for describing the present exemplary example embodiment can be employed in the other exemplary example embodiments included in the present disclosure within the scope in which no particular technical problem occurs.

### Configuration of Exercise Assistance System

A configuration of an exercise assistance system 100 will be described with reference to FIG. 14. FIG. 14 is a block diagram illustrating a configuration of the exercise assistance system 100. In the block diagram illustrated in FIG. 14, each block of each device of the exercise assistance system 100 is disposed according to the flow of processing. Therefore, a plurality of blocks used a plurality of times at different timings is illustrated.

As illustrated in FIG. 14, the exercise assistance system 100 includes a server 101, a user terminal 102, and a coach terminal 103. The server 101 and the user terminal 102 are configured to be able to communicate with each other via a network. The server 101 and the coach terminal 103 are configured to be able to communicate with each other via a network.

The server 101 includes a first selection unit 11, a second selection unit 12, an advice generation unit 13, a first video division unit 14, a second video division unit 15, a voice division unit 16, a voice analysis unit 17, and an extraction unit 18. The first selection unit 11, the second selection unit 12, the advice generation unit 13, the first video division unit 14, the second video division unit 15, the voice division unit 16, the voice analysis unit 17, and the extraction unit 18 included in the server 101 function as in the first selection unit 11, the second selection unit 12, the advice generation unit 13, the first video division unit 14, the second video division unit 15, the voice division unit 16, the voice analysis unit 17, and the extraction unit 18 included in the exercise assistance device 1A, respectively.

The user terminal 102 is configured to record the instructed environment video and the uninstructed environment video. The coach terminal 103 is configured to record the instructed environment voice.

The exercise assistance system 100 operates as follows.

When the exercise in the instructed environment ends, the user terminal 102 transmits the recorded instructed environment video to the server 101 via the network. The server 101 generates the unit exercise video indicating the motion of the target user TU performing each unit exercise Est constituting the exercise Es in the instructed environment from the instructed environment video received from the user terminal 102 using the first video division unit 14 and the second video division unit 15.

When the exercise in the instructed environment ends, the coach terminal 103 transmits the recorded instructed environment voice to the server 101 via the network. The server 101 selects the erroneous motion class related to the motion of the target user TU that performs each unit exercise Est constituting the exercise Es in the instructed environment from the instructed environment voice received from the coach terminal 103 using the voice division unit 16, the voice analysis unit 17, the extraction unit 18, and the first selection unit 11.

For each unit exercise Est constituting the exercise Es, the tuning unit 121 of the server 101 generates tuning data by combining a unit exercise video indicating the motion of the user who performs the unit exercise Est in the instructed environment with an erroneous motion class related to the motion of the user who performs the unit exercise Est in the instructed environment. The tuning unit 121 of the server 101 generates the individual optimization model M2 by additional learning using the generated tuning data.

When the exercise in the uninstructed environment ends, the user terminal 102 transmits the recorded uninstructed environment video to the server 101 via the network. The server 101 generates the unit exercise video indicating the motion of the target user TU performing each unit exercise Est constituting the exercise Es in the uninstructed environment from the uninstructed environment video received from the user terminal 102 using the first video division unit 14 and the second video division unit 15.

The second selection unit 12 of the server 101 selects the erroneous motion class related to the motion of the target user TU who performs each unit exercise Est constituting the exercise Es in the instructed environment using the individual optimization model M2 generated by the tuning unit 121. The advice generation unit 13 of the server 101 generates advice to be presented to the target user TU with reference to the erroneous motion class selected by the second selection unit 12. The server 101 transmits the advice generated by the advice generation unit 13 to the user terminal 102, and the user terminal 102 presents the received advice to the target user TU.

The server 101 may further include the extraction/summary unit 19, the explanatory video generation unit 21, and the synthesis unit 22 described above. As a result, the server 101 can generate the explanatory sentence, the explanatory video, and the multimedia content described above.

### First Modified Example of Exercise Assistance System

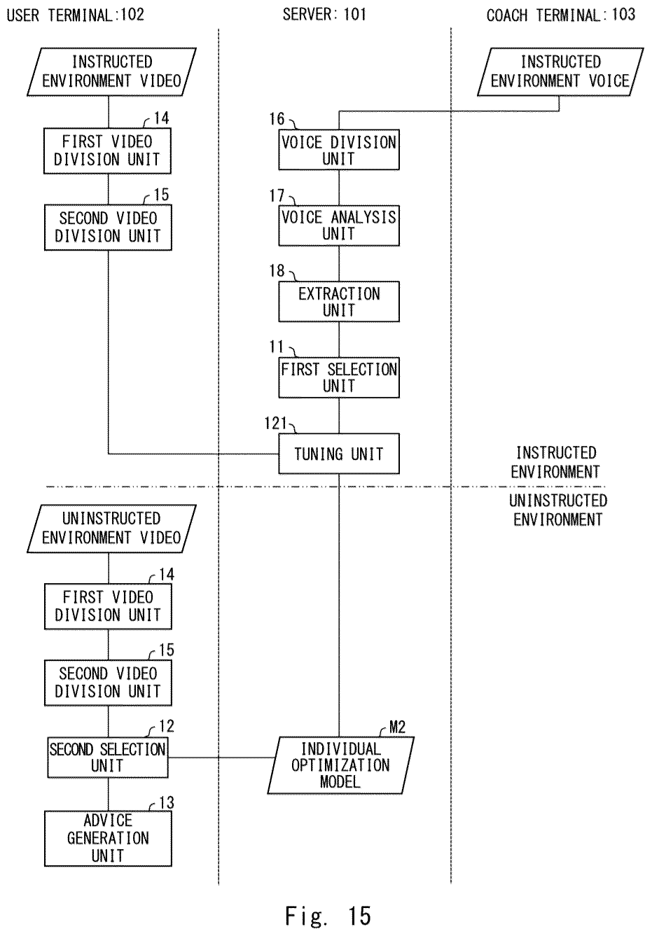

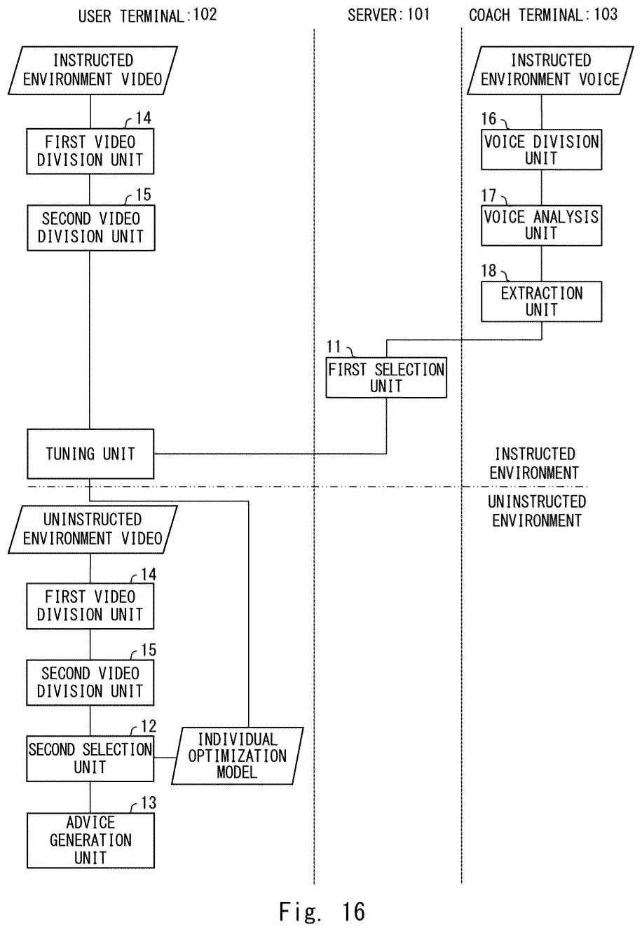

The first modified example (hereinafter, described as an exercise assistance system 100A) of the exercise assistance system 100 will be described with reference to FIG. 15. FIG. 15 is a block diagram illustrating a configuration of the exercise assistance system 100A. In the block diagram illustrated in FIG. 15, each block of each device of the exercise assistance system 100A is disposed according to the flow of processing. Therefore, a plurality of blocks used a plurality of times at different timings is illustrated.

The server 101 includes a first selection unit 11, a voice division unit 16, a voice analysis unit 17, an extraction unit 18, and a tuning unit 121. The user terminal 102 is configured to record the instructed environment video and the uninstructed environment video, and includes a second selection unit 12, an advice generation unit 13, a first video division unit 14, and a second video division unit 15. The coach terminal 103 is configured to record the instructed environment voice.

The exercise assistance system 100A operates as follows.

When the exercise in the instructed environment ends, the user terminal 102 generates the unit exercise video indicating the motion of the target user TU performing each unit exercise Est constituting the exercise Es in the instructed environment from the recorded instructed environment video using the first video division unit 14 and the second video division unit 15. The user terminal 102 transmits the generated unit exercise video to the server 101.

When the exercise in the instructed environment ends, the coach terminal 103 transmits the recorded instructed environment voice to the server 101 via the network. The server 101 selects the erroneous motion class related to the motion of the target user TU that performs each unit exercise Est constituting the exercise Es in the instructed environment from the instructed environment voice received from the coach terminal 103 using the voice division unit 16, the voice analysis unit 17, the extraction unit 18, and the first selection unit 11.

For each unit exercise Est constituting the exercise Es, the tuning unit 121 of the server 101 generates tuning data by combining a unit exercise video (acquired from the user terminal 102) indicating the motion of the user who performs the unit exercise Est in the instructed environment with an erroneous motion class (generated by the tuning unit) related to the motion of the user who performs the unit exercise Est in the instructed environment. The tuning unit 121 of the server 101 generates the individual optimization model M2 by additional learning using the generated tuning data. The server 101 transmits the generated individual optimization model M2 to the user terminal 102.

When the exercise in the uninstructed environment ends, the user terminal 102 generates the unit exercise video indicating the motion of the target user TU performing each unit exercise Est constituting the exercise Es in the uninstructed environment from the recorded uninstructed environment video using the first video division unit 14 and the second video division unit 15.

The second selection unit 12 of the user terminal 102 selects the erroneous motion class related to the motion of the target user TU who performs each unit exercise Est constituting the exercise Es in the instructed environment using the individual optimization model M2 received from the server 101. The advice generation unit 13 of the user terminal 102 generates advice to be presented to the target user TU with reference to the erroneous motion class selected by the second selection unit 12. The user terminal 102 presents the advice generated by the advice generation unit 13 to the target user TU.

The server 101 may further include the extraction/summary unit 19, the explanatory video generation unit 21, and the synthesis unit 22 described above. As a result, the server 101 can generate the explanatory sentence, the explanatory video, and the multimedia content described above.

According to the exercise assistance system 100A, machine learning for generating the individual optimization model M2 is performed in the server 101. Therefore, the exercise assistance can be performed without applying an excessive load to the user terminal 102. In a case where there is a plurality of users, the individual optimization model M2 related to each user can be centrally managed in the server 101.

### Second Modified Example of Exercise Assistance System

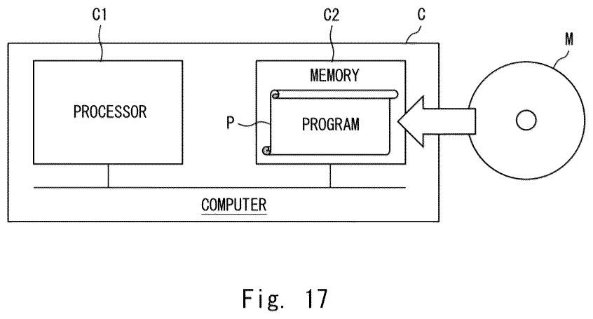

The second modified example (hereinafter, described as an exercise assistance system 100B) of the exercise assistance system 100 will be described with reference to FIG. 16. FIG. 16 is a block diagram illustrating a configuration of the exercise assistance system 100B. In the block diagram illustrated in FIG. 16, each block of each device of the exercise assistance system 100B is disposed according to the flow of processing. Therefore, a plurality of blocks used a plurality of times at different timings is illustrated.

The server 101 includes a first selection unit 11. The user terminal 102 is configured to record the instructed environment video and the uninstructed environment video, and includes a second selection unit 12, an advice generation unit 13, a first video division unit 14, a second video division unit 15, and a tuning unit 121. The coach terminal 103 is configured to record an instructed environment voice, and includes a first selection unit 11, a voice division unit 16, a voice analysis unit 17, and an extraction unit 18.

The exercise assistance system 100 operates as follows.

When the exercise in the instructed environment ends, the user terminal 102 generates the unit exercise video indicating the motion of the target user TU performing each unit exercise Est constituting the exercise Es in the instructed environment from the recorded instructed environment video using the first video division unit 14 and the second video division unit 15.

When the exercise in the instructed environment ends, the coach terminal 103 extracts the instruction content for the motion of the target user TU performing each unit exercise Est constituting the exercise Es in the instructed environment from the recorded instructed environment voice using the voice division unit 16, the voice analysis unit 17, and the extraction unit 18. The coach terminal 103 transmits the extracted instruction content to the server 101. The server 101 selects, from the received instruction content, the erroneous motion class related to the motion of the target user TU that performs each unit exercise Est constituting the exercise Es in the instructed environment using the first selection unit 11. Using the server 101, the coach terminal 103 transmits the selected erroneous motion class to the user terminal 102.

For each unit exercise Est constituting the exercise Es, the tuning unit 121 of the user terminal 102 generates tuning data by combining a unit exercise video (generated by the tuning unit) indicating the motion of the user who performs the unit exercise Est in the instructed environment with an erroneous motion class (received from the server 101) related to the motion of the user who performs the unit exercise Est in the instructed environment. The tuning unit 121 of the user terminal 102 generates the individual optimization model M2 by additional learning using the generated tuning data.

When the exercise in the uninstructed environment ends, the user terminal 102 generates the unit exercise video indicating the motion of the target user TU performing each unit exercise Est constituting the exercise Es in the uninstructed environment from the recorded uninstructed environment video using the first video division unit 14 and the second video division unit 15.

The second selection unit 12 of the user terminal 102 selects the erroneous motion class related to the motion of the target user TU performing each unit exercise Est constituting the exercise Es in the instructed environment using the generated individual optimization model M2. The advice generation unit 13 of the user terminal 102 generates advice to be presented to the target user TU with reference to the erroneous motion class selected by the second selection unit 12. The user terminal 102 presents the advice generated by the advice generation unit 13 to the target user TU.

The coach terminal 103 may further include the extraction/summary unit 19 described above. As a result, the coach terminal 103 can generate the above-described explanatory sentence. The user terminal 102 may further include an explanatory video generation unit 21 and a synthesis unit 22. As a result, the server 101 can generate the above-described explanatory video and multimedia content.

According to the exercise assistance system 100B, machine learning for generating the individual optimization model M2 is performed in the user terminal 102. Therefore, the exercise assistance can be performed without applying an excessive load to the server 101. In a case where there is a plurality of users, the individual optimization model M2 related to each user can be distributedly managed in the user terminal 102 of each user.

### Example of Implementation by Software

Some or all of the functions of the exercise assistance devices 1, 1A, and 1B, and each device (hereinafter, described as “the above each device”) constituting the exercise assistance system 100 may be implemented by hardware such as an integrated circuit (IC chip) or may be implemented by software.

In the latter case, the above each device is implemented by, for example, a computer that performs a command of a program which is software for implementing each function. An example of such a computer (hereinafter, described as a computer C) is illustrated in FIG. 17. FIG. 17 is a block diagram illustrating a hardware configuration of the computer C functioning as the above each device.

The computer C includes at least one processor C1 and at least one memory C2. A program P causing the computer C to operate as the above each device is recorded in the memory C2. In the computer C, the processor C1 reads the program P from the memory C2 and performs the program P to implement each function of the above each device.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof can be used. As the memory C2, for example, a flash memory, a hard disk drive (HDD), a solid state drive (SSD), or a combination thereof can be used.

The computer C may further include a random access memory (RAM) for loading the program P at the time of execution and temporarily storing various types of data. The computer C may further include a communication interface for transmitting and receiving data to and from other devices. The computer C may further include an input/output interface that connects input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, a programmable logic circuit, or the like can be used. The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

Each of the above functions of the above each device may be implemented by single processor provided in a single computer, may be implemented in cooperation with a plurality of processors provided in a single computer, or may be implemented in cooperation with a plurality of processors provided in a plurality of computers. The program causing the above each device to implement each of the above functions may be stored in one memory provided in a single computer, may be stored in a distributed manner in a plurality of memories provided in a single computer, or may be stored in a distributed manner in a plurality of memories provided in a plurality of computers.

### Supplementary Note Item 1

The present disclosure includes technologies described in the following Supplementary Notes. However, the present disclosure is not limited to the technologies described in the following Supplementary Notes, and various modifications can be made.

### Supplementary Note 1

An exercise assistance device including
a first selection means for referring to instruction content for a target user who is performing an exercise in an instructed environment and selecting an erroneous motion class related to the instruction content from among a plurality of erroneous motion classes,
a second selection means for referring to a video indicating a motion of the target user who is performing the exercise in an uninstructed environment and selecting an erroneous motion class related to the motion from among erroneous motion classes selected by the first selection means, and
an advice generation means for referring to the erroneous motion class selected by the second selection means and generating advice to be presented to the target user who performs the exercise in the uninstructed environment.

### Supplementary Note 2

The exercise assistance device according to Supplementary Note 1, wherein the second selection means further includes
a tuning means for generating, by machine learning using tuning data including a video indicating a motion of the target user who is performing the exercise in the instructed environment and erroneous motion classes selected by the first selection means, an individual optimization model in which an input is a video indicating a motion of the user who is performing the exercise and an output is any of the erroneous motion classes selected by the first selection means from a general model in which an input is a video indicating the motion of the user who is performing the exercise and an output is any of the plurality of erroneous motion classes, and
selects an erroneous motion class output from the individual optimization model when a video indicating a motion of the target user who is performing the exercise in the uninstructed environment is input to the individual optimization model as an erroneous motion class related to the motion.

### Supplementary Note 3

The exercise assistance device according to any one of Supplementary Notes 1 and 2, wherein
the exercise is configured by repeating a unit exercise,
the first selection means selects, for each unit exercise, an erroneous motion class related to an erroneous motion of the target user in the unit exercise with reference to an instruction content for the target user who is performing the exercise in the instructed environment, and
the second selection means selects, for each unit exercise, an erroneous motion class related to an erroneous motion of the target user in the unit exercise with reference to a video indicating a motion of the target user who is performing the exercise in the uninstructed environment.

### Supplementary Note 4

The exercise assistance device according to any one of Supplementary Notes 1 to 3, further including an extraction means for extracting instruction content for the target user who is performing the exercise in the instructed environment from utterance content of a coach who instructs the target user who is performing the exercise in the instructed environment,
wherein the first selection means refers to the instruction content extracted by the extraction means and selects an erroneous motion class related to the instruction content from the plurality of erroneous motion classes.

### Supplementary Note 5

The exercise assistance device according to any one of Supplementary Notes 1 to 4, further including an explanatory sentence generation means for generating an explanatory sentence to be presented to the target user who performs the exercise in the uninstructed environment by summarizing utterance content of a coach who instructs the target user who is performing the exercise in the instructed environment.

### Supplementary Note 6

The exercise assistance device according to any one of Supplementary Notes 1 to 5, further including
an extraction means for extracting instruction content for the target user who is performing the exercise in the instructed environment from utterance content of a coach who instructs the target user who is performing the exercise in the instructed environment, and
an explanatory video generation means for generating an explanatory video to be presented to the target user who performs the exercise in the uninstructed environment with reference to a video indicating a motion of the target user who is performing the exercise in the instructed environment and instruction content extracted by the extraction means.

### Supplementary Note 7

An exercise assistance system including a server and a terminal, wherein
the server includes
a first selection means for referring to instruction content for a target user who is performing an exercise in an instructed environment and selecting an erroneous motion class related to the instruction content from among a plurality of erroneous motion classes, and
a tuning means for generating, by machine learning using tuning data including a video indicating a motion of the target user who is performing the exercise in the instructed environment and erroneous motion classes selected by the first selection means, an individual optimization model in which an input is a video indicating a motion of the user who is performing the exercise and an output is any of the erroneous motion classes selected by the first selection means from a general model in which an input is a video indicating a motion of the user who is performing the exercise and an output is any of the plurality of erroneous motion classes, and
the terminal includes
a second selection means for referring to a video indicating a motion of the target user who is performing the exercise in an uninstructed environment and selecting an erroneous motion class related to the motion from among erroneous motion classes selected by the first selection means, the second selection means selecting, as an erroneous motion class related to the motion, an erroneous motion class output from the individual optimization model when a video indicating a motion of the target user who is performing the exercise in the uninstructed environment is input to the individual optimization model, and
an advice generation means for referring to the erroneous motion class selected by the second selection means and generating advice to be presented to the target user who performs the exercise in the uninstructed environment.

### Supplementary Note 8

An exercise assistance system including a server and a terminal, wherein
the server includes a first selection means for referring to instruction content for a target user who is performing an exercise in an instructed environment and selecting an erroneous motion class related to the instruction content from among a plurality of erroneous motion classes, and
the terminal includes
a tuning means for generating, by machine learning using tuning data including a video indicating a motion of the target user who is performing the exercise in the instructed environment and erroneous motion classes selected by the first selection means, an individual optimization model in which an input is a video indicating a motion of the user who is performing the exercise and an output is any of the erroneous motion classes selected by the first selection means from a general model in which an input is a video indicating a motion of the user who is performing the exercise and an output is any of the plurality of erroneous motion classes,
a second selection means for referring to a video indicating a motion of the target user who is performing the exercise in an uninstructed environment and selecting an erroneous motion class related to the motion from among erroneous motion classes selected by the first selection means, the second selection means selecting, as an erroneous motion class related to the motion, an erroneous motion class output from the individual optimization model when a video indicating a motion of the target user who is performing the exercise in the uninstructed environment is input to the individual optimization model, and
an advice generation means for referring to the erroneous motion class selected by the second selection means and generating advice to be presented to the target user who performs the exercise in the uninstructed environment.

### Supplementary Note 9

An exercise assistance method including
a first selection process of at least one processor referring to instruction content for a target user who is performing an exercise in an instructed environment and selecting an erroneous motion class related to the instruction content from among a plurality of erroneous motion classes,
a second selection process of the at least one processor referring to a video indicating a motion of the target user who is performing the exercise in an uninstructed environment and selecting an erroneous motion class related to the motion from among the erroneous motion classes selected by the first selection process, and
an advice generation process of the at least one processor referring to the erroneous motion class selected by the second selection process and generating advice to be presented to the target user who performs the exercise in the uninstructed environment.

### Supplementary Note 10

An exercise assistance program for causing a computer to operate as the exercise assistance device according to any one of Supplementary Notes 1 to 6, the exercise assistance program causing the computer to function as the above each means.

### Supplementary Note Item 2

The present disclosure includes technologies described in the following Supplementary Notes. However, the present disclosure is not limited to the technologies described in the following Supplementary Notes, and various modifications can be made.

### Supplementary Note 1

An exercise assistance device including at least one processor,
wherein the at least one processor executes
a first selection process of referring to instruction content for a target user who is performing an exercise in an instructed environment and selecting an erroneous motion class related to the instruction content from among a plurality of erroneous motion classes,
a second selection process of referring to a video indicating a motion of the target user who is performing the exercise in an uninstructed environment and selecting an erroneous motion class related to the motion from among the erroneous motion classes selected by the first selection process, and
an advice generation process of referring to the erroneous motion class selected by the second selection process and generating advice to be presented to the target user who performs the exercise in the uninstructed environment.

### Supplementary Note 2

The exercise assistance device according to Supplementary Note 1, wherein
the at least one processor executes a tuning process of generating, by machine learning using tuning data including a video indicating a motion of the target user who is performing the exercise in the instructed environment and an erroneous motion class selected by the first selection process, an individual optimization model in which an input is a video indicating a motion of the user who is performing the exercise and an output is any of erroneous motion classes selected by the first selection process from a general model in which an input is a video indicating the motion of the user who is performing the exercise and an output is any of the plurality of erroneous motion classes, and
in the second selection process, the at least one processor selects an erroneous motion class output from the individual optimization model when a video indicating a motion of the target user who is performing the exercise in the uninstructed environment is input to the individual optimization model as an erroneous motion class related to the motion.

### Supplementary Note 3

The exercise assistance device according to Supplementary Note 1, wherein
the exercise is configured by repeating a unit exercise,
in the first selection process, the at least one processor selects, for each unit exercise, an erroneous motion class related to an erroneous motion of the target user in the unit exercise with reference to an instruction content for the target user who is performing the exercise in the instructed environment, and
in the second selection process, the at least one processor selects, for each unit exercise, an erroneous motion class related to an erroneous motion of the target user in the unit exercise with reference to a video indicating a motion of the target user who is performing the exercise in the uninstructed environment.

### Supplementary Note 4

The exercise assistance device according to Supplementary Note 1, wherein
the at least one processor further executes an extraction process of extracting instruction content for the target user who is performing the exercise in the instructed environment from utterance content of a coach who instructs the target user who is performing the exercise in the instructed environment, and
in the first selection process, the at least one processor refers to the instruction content extracted by the extraction process and selects an erroneous motion class related to the instruction content from the plurality of erroneous motion classes.

### Supplementary Note 5

The exercise assistance device according to Supplementary Note 1, wherein the at least one processor executes an explanatory sentence generation process of generating an explanatory sentence to be presented to the target user who performs the exercise in the uninstructed environment by summarizing utterance content of a coach who instructs the target user who is performing the exercise in the instructed environment.

### Supplementary Note 6

The exercise assistance device according to Supplementary Note 1, wherein the at least one processor further executes
an extraction process of extracting instruction content for the target user who is performing the exercise in the instructed environment from utterance content of a coach who instructs the target user who is performing the exercise in the instructed environment, and
an explanatory video generation process of generating an explanatory video to be presented to the target user who performs the exercise in the uninstructed environment with reference to a video indicating a motion of the target user who is performing the exercise in the instructed environment and instruction content extracted by the extraction process.

### Supplementary Note 7

An exercise assistance system including a server including at least one processor and a terminal including at least one processor, wherein
the at least one processor of the server executes
a first selection process of referring to instruction content for a target user who is performing an exercise in an instructed environment and selecting an erroneous motion class related to the instruction content from among a plurality of erroneous motion classes, and
a tuning process of generating, by machine learning using tuning data including a video indicating a motion of the target user who is performing the exercise in the instructed environment and an erroneous motion class selected by the first selection process, an individual optimization model in which an input is a video indicating a motion of the user who is performing the exercise and an output is any of erroneous motion classes selected by the first selection process from a general model in which an input is a video indicating a motion of the user who is performing the exercise and an output is any of the plurality of erroneous motion classes, and
the at least one processor of the terminal executes
a second selection process of referring to a video indicating a motion of the target user who is performing the exercise in the uninstructed environment and selecting an erroneous motion class related to the motion from among the erroneous motion classes selected by the first selection process, the second selection process selecting an erroneous motion class output from the individual optimization model when a video indicating a motion of the target user who is performing the exercise in the uninstructed environment is input to the individual optimization model as an erroneous motion class related to the motion, and
an advice generation process of referring to the erroneous motion class selected by the second selection process and generating advice to be presented to the target user who performs the exercise in the uninstructed environment.

### Supplementary Note 8

An exercise assistance system including a server including at least one processor and a terminal including at least one processor, wherein
the at least one processor of the server executes a first selection process of referring to instruction content for a target user who is performing an exercise in an instructed environment and selecting an erroneous motion class related to the instruction content from among a plurality of erroneous motion classes, and
the at least one processor of the terminal executes
a tuning process of generating, by machine learning using tuning data including a video indicating a motion of the target user who is performing the exercise in the instructed environment and an erroneous motion class selected by the first selection process, an individual optimization model in which an input is a video indicating a motion of the user who is performing the exercise and an output is any of erroneous motion classes selected by the first selection process from a general model in which an input is a video indicating a motion of the user who is performing the exercise and an output is any of the plurality of erroneous motion classes,
a second selection process of referring to a video indicating a motion of the target user who is performing the exercise in the uninstructed environment and selecting an erroneous motion class related to the motion from among the erroneous motion classes selected by the first selection process, the second selection process selecting an erroneous motion class output from the individual optimization model when a video indicating a motion of the target user who is performing the exercise in the uninstructed environment is input to the individual optimization model as an erroneous motion class related to the motion, and
an advice generation process of referring to the erroneous motion class selected by the second selection process and generating advice to be presented to the target user who performs the exercise in the uninstructed environment.

### Supplementary Note 9

An exercise assistance method including
a first selection process of at least one processor referring to instruction content for a target user who is performing an exercise in an instructed environment and selecting an erroneous motion class related to the instruction content from among a plurality of erroneous motion classes,
a second selection process of the at least one processor referring to a video indicating a motion of the target user who is performing the exercise in an uninstructed environment and selecting an erroneous motion class related to the motion from among the erroneous motion classes selected by the first selection process, and
an advice generation process of the at least one processor referring to the erroneous motion class selected by the second selection process and generating advice to be presented to the target user who performs the exercise in the uninstructed environment.

### Supplementary Note 10

A non-transitory tangible recording medium readable by a computer, the recording medium recording an exercise assistance program for causing the computer to operate as the exercise assistance device according to Supplementary Note 1, the exercise assistance program causing the computer to function as the above each process.

1. An exercise assistance device comprising:
at least one memory storing instructions, and
at least one processor configured to execute the instructions to:
refer to instruction content for a target user who is performing an exercise in an instructed environment and selecting an erroneous motion class related to the instruction content from among a plurality of erroneous motion classes;
refer to a video indicating a motion of the target user who is performing the exercise in an uninstructed environment and select an erroneous motion class related to the motion from among erroneous motion classes selected by the first selection means; and
refer to the erroneous motion class selected by the second selection means and generating advice to be presented to the target user who performs the exercise in the uninstructed environment.

2. The exercise assistance device according to claim 1, wherein the at least one processor configured to execute the instructions to:
generate, by machine learning using tuning data including a video indicating a motion of the target user who is performing the exercise in the instructed environment and erroneous motion classes selected, an individual optimization model in which an input is a video indicating a motion of the user who is performing the exercise and an output is any of the erroneous motion classes selected from a general model in which an input is a video indicating the motion of the user who is performing the exercise and an output is any of the plurality of erroneous motion classes, and
select an erroneous motion class output from the individual optimization model when a video indicating a motion of the target user who is performing the exercise in the uninstructed environment is input to the individual optimization model as an erroneous motion class related to the motion.

3. The exercise assistance device according to claim 1, wherein
the exercise is configured by repeating a unit exercise and
the at least one processor configured to execute the instructions to:
select, for each unit exercise, an erroneous motion class related to an erroneous motion of the target user in the unit exercise with reference to an instruction content for the target user who is performing the exercise in the instructed environment; and
select, for each unit exercise, an erroneous motion class related to an erroneous motion of the target user in the unit exercise with reference to a video indicating a motion of the target user who is performing the exercise in the uninstructed environment.

4. The exercise assistance device according to claim 1, wherein the at least one processor configured to execute the instructions to:
extract instruction content for the target user who is performing the exercise in the instructed environment from utterance content of a coach who instructs the target user who is performing the exercise in the instructed environment; and
refer to the instruction content extracted by the extraction means and select an erroneous motion class related to the instruction content from the plurality of erroneous motion classes.

5. The exercise assistance device according to claim 1, wherein the at least one processor configured to execute the instructions to generate an explanatory sentence to be presented to the target user who performs the exercise in the uninstructed environment by summarizing utterance content of a coach who instructs the target user who is performing the exercise in the instructed environment.

6. The exercise assistance device according to claim 1, wherein the at least one processor configured to execute the instructions to:
extract instruction content for the target user who is performing the exercise in the instructed environment from utterance content of a coach who instructs the target user who is performing the exercise in the instructed environment; and
generate an explanatory video to be presented to the target user who performs the exercise in the uninstructed environment with reference to a video indicating a motion of the target user who is performing the exercise in the instructed environment and instruction content extracted by the extraction means.

7. An exercise assistance method comprising:
a first selection process of at least one processor referring to instruction content for a target user who is performing an exercise in an instructed environment and selecting an erroneous motion class related to the instruction content from among a plurality of erroneous motion classes;
a second selection process of the at least one processor referring to a video indicating a motion of the target user who is performing the exercise in an uninstructed environment and selecting an erroneous motion class related to the motion from among the erroneous motion classes selected by the first selection process; and
an advice generation process of the at least one processor referring to the erroneous motion class selected by the second selection process and generating advice to be presented to the target user who performs the exercise in the uninstructed environment.

8. A non-transitory computer readable medium recording an exercise assistance program, the exercise assistance program for causing a computer to operate as the exercise assistance device according to claim 1, the exercise assistance program causing the computer to function as the above each means.
